(19) United States
(12) Patent Application Publication
(10) Pub. No.: US 2018/0213290 A1
(43) Pub. Date: Jul. 26, 2018

(54) CONTEXTUAL USER INTERFACE BASED ON MEDIA PLAYBACK

(71) Applicant: Essential Products, Inc., Palo Alto, CA (US)

(72) Inventors: Manuel Roman, Sunnyvale, CA (US); Mara Clair Segal, San Francisco, CA (US); Dwipal Desai, Palo Alto, CA (US); Andrew E. Rubin, Los Altos, CA (US)

(21) Appl. No.: 15/600,563

(22) Filed: May 19, 2017

Related U.S. Application Data
(63) Continuation-in-part of application No. 15/587,201, filed on May 4, 2017.
(60) Provisional application No. 62/506,168, filed on May 15, 2017.
(60) Provisional application No. 62/448,912, filed on Jan. 20, 2017.
(60) Provisional application No. 62/486,359, filed on Apr. 17, 2017.
(60) Provisional application No. 62/486,365, filed on Apr. 17, 2017.

(51) Int. Cl. H04N 21/472; H04N 21/482; H04N 21/442; H04N 21/234; H04N 21/25

(52) U.S. Cl. CPC H04N 21/47217; H04N 21/482; G06F 3/04886; H04N 21/23418; H04N 21/251; H04N 21/44222

(57) ABSTRACT

A contextual user interface based on playback of media content is described. An assistant device can determine that a display device (e.g., television) within its environment is playing back media content on different channels. The channels being watched can be provided to a server, which can provide back information regarding the media content being played back on those channels. The assistant device can then generate buttons on the user interface providing the information regarding the media content and also causing the display device to switch channels upon their selection.

### CLAIM FOR PRIORITY

This application claims priority to U.S. Provisional Patent Application No. 62/506,168 (Attorney Docket No. 119306-8081.US00), entitled “Contextual User Interface Based on Media Playback,” by Roman et al., and filed on May 15, 2017. This application is also a continuation-in-part of U.S. patent application Ser. No. 15/587,201 (Attorney Docket No. 119306-8061.US01), entitled “Contextual User Interface Based on Environment,” by Roman et al., and filed on May 4, 2017, which claims priority to U.S. Provisional Patent Application No. 62/448,912 (Attorney Docket No. 119306-8040.US00), entitled “Contextual User Interface Based on Environment,” by Roman et al., and filed on Jan. 20, 2017, U.S. Provisional Patent Application No. 62/486,359 (Attorney Docket No. 119306-8061.US00), entitled “Contextual User Interface Based on Environment,” by Roman et al., and filed on Apr. 17, 2017, and U.S. Provisional Patent Application No. 62/486,365 (Attorney Docket No. 119306-8062.US00), entitled “Contextual User Interface Based on Changes in Environment,” by Roman et al., and filed on Apr. 17, 2017. The content of the above-identified applications are incorporated herein by reference in their entirety.

### TECHNICAL FIELD

This disclosure relates to user interfaces, and in particular a user interface that is adaptive based on the context of the environment.

### BACKGROUND

The Internet of Things (IoT) allows for the internetworking of devices to exchange data among themselves to enable sophisticated functionality. For example, devices configured for home automation can exchange data to allow for the control and automation of lighting, air conditioning systems, security, etc. In the smart home environment, this can also include home assistant devices providing an intelligent personal assistant to respond to speech. For example, a home assistant device can include a microphone array to receive voice input and provide the corresponding voice data to a server for analysis to provide an answer to a question asked by a user. The server can provide that answer to the home assistant device, which can provide the answer as voice output using a speaker. As another example, the user can provide a voice command to the home assistant device to control another device in the home, for example, a command to turn a light bulb on or off. As such, the user and the home assistant device can interact with each other using voice, and the interaction can be supplemented by a server outside of the home providing the answers. However, homes can have different users interacting with the home assistant device within different contextual environments (e.g., from different locations and at different times) within the home.

### SUMMARY

Some of the subject matter described herein includes a method for providing a graphical user interface (GUI) on a touchscreen of a home assistant device with artificial intelligence (AI) capabilities, the GUI providing content related to playback of media content within an environment of the home assistant device, comprising: identifying infrared (IR) signals generated by a remote control and directed to a display device configured to provide playback of media content; determining that the IR signals represent that the display device should play back a first media content by selecting a first channel and that the display device should play back a second media content by selecting a second channel, the first channel and the second played back at different times, the first channel and the second channel being different sources of live playback of media content; providing watched channel information to a server, the watched channel information representing that the first channel and the second channel are being watched on the display device within the environment of the home assistant device; receiving media content information from the server, the media content information representing information regarding the first media content being played back on the first channel and regarding the second media content being played back on the second channel, the media content information indicating that the first media content and the second media content are providing playback of sports games and providing information regarding scores of the sports games being played back on the first channel and the second channel; receiving similar channel information from the server, the similar channel information indicating a third channel providing playback of a third media content similar to one or both of the first media content or the second media content, the third channel not indicated in the watched channel information that represents channels being watched on the display device; determining that the first channel providing playback of the first media content is currently selected by the display device for playback of the first media content; generating a first hot button for display on the GUI of the touchscreen of the home assistant device based on the determination that the first channel is currently selected by the display device for playback of the first media content, the first hot button providing detail regarding a first score of the sports game being played back on the first channel; generating a second hot button for display on the GUI of the touchscreen of the home assistant device based on the determination that the first channel is currently selected by the display device for playback of the first media content, the second hot button providing detail regarding a second score of the sports game being played back on the third channel; determining that the first hot button or the second hot button was selected via a touch on the touchscreen of the home assistant device; and transmitting an IR signal representing that the display device should switch from playing back the first media content on the first channel to playing back the media content corresponding to the channel associated with the first hot button or the second hot button that was selected.

Some of the subject matter described herein also includes a method, comprising: determining, by a processor of an assistant device, that a display device in an environment with the assistant device has played back a first media content selected via a first channel and that the display device has played back a second media content selected via a second channel; providing watched channel information to a server, the watched channel information representing that the display device is switching among the first channel and the second channel to provide playback of the first media content and the second media content; receiving media content information from the server, the media content information representing information regarding the first media content being played back on the first channel; generating, by the processor, a first hot button on a graphical user interface (GUI) displayed upon a display of the assistant device, the first hot button providing the media content information representing information regarding the first media content; and instructing the display device to switch from playing back the second media content via the second channel to play back the first media content via the first channel based on a selection of the first hot button.

In some implementations, the method includes determining that the display device has played back the first media content selected via the first channel and that the display device has played back the second media content selected via the second channel includes identifying infrared (IR) signals generated by a remote control, the IR signals instructing the display device to change channels.

In some implementations, the method includes receiving similar channel information from the server, the similar channel information indicating a third channel providing playback of a third media content similar to one or both of the first media content or the second media content, the third channel not indicated in the watched channel information that represents channels being watched on the display device; and generating a second hot button on the GUI, the second hot button configured to cause the assistant device to instruct the display device to switch playback to the third media content by selecting the third channel.

In some implementations, the method includes instructing the display device to switch from playing back the second media content via the second channel to play back the first media content via the first channel based on the selection of the first hot button includes transmitting infrared (IR) signals to the display device, the IR signals representing that the display device should select the first channel.

In some implementations, the method includes receiving graphical content related to similar subject matter of both of the first media content and the second media content; and displaying the graphical content on the GUI with the first hot button.

In some implementations, the method includes determining that the second channel providing playback is currently selected by the display device for playback, wherein generating the first hot button is based on the determination that the second channel is currently selected by the display device for playback.

In some implementations, the media content information representing information regarding the first media content being played back on the first channel includes a characteristic of a live broadcast corresponding to the first media content.

In some implementations, the method includes determining that the first channel and the second channel have each been selected for playback on the display device for a threshold number range within a threshold time duration, wherein the watched channel information is based on the determination that the first channel and the second channel have each been selected for playback on the display device for the threshold number range within the threshold time duration.

In some implementations, the method includes determining activity of a user watching the display device, wherein the watched channel information is based on the determination regarding the activity of the user watching the display device.

Some of the subject matter described herein also includes a computer program product, comprising one or more non-transitory computer-readable media having computer program instructions stored therein, the computer program instructions being configured such that, when executed by one or more computing devices, the computer program instructions cause the one or more computing devices to: determine that a display device in an environment with an assistant device has played back a first media content selected via a first channel and that the display device has played back a second media content selected via a second channel; provide watched channel information to a server, the watched channel information representing that the display device is switching among the first channel and the second channel to provide playback of the first media content and the second media content; receive media content information from the server, the media content information representing information regarding the first media content being played back on the first channel; generate a first hot button on a graphical user interface (GUI) displayed upon a display of the assistant device, the first hot button providing the media content information representing information regarding the first media content; and instruct the display device to switch from playing back the second media content via the second channel to play back the first media content via the first channel based on a selection of the first hot button.

In some implementations, determining that the display device has played back the first media content selected via the first channel and that the display device has played back the second media content selected via the second channel includes identifying infrared (IR) signals generated by a remote control, the IR signals instructing the display device to change channels.

In some implementations, the computer program instructions cause the one or more computing devices to: receive similar channel information from the server, the similar channel information indicating a third channel providing playback of a third media content similar to one or both of the first media content or the second media content, the third channel not indicated in the watched channel information that represents channels being watched on the display device; and generate a second hot button on the GUI, the second hot button configured to cause the assistant device to instruct the display device to switch playback to the third media content by selecting the third channel.

In some implementations, instructing the display device to switch from playing back the second media content via the second channel to play back the first media content via the first channel based on the selection of the first hot button includes transmitting infrared (IR) signals to the display device, the IR signals representing that the display device should select the first channel.

In some implementations, the computer program instructions cause the one or more computing devices to: receive graphical content related to similar subject matter of both of the first media content and the second media content; and display the graphical content on the GUI with the first hot button.

In some implementations, the computer program instructions cause the one or more computing devices to determine that the second channel providing playback is currently selected by the display device for playback, wherein generating the first hot button is based on the determination that the second channel is currently selected by the display device for playback.

In some implementations, the media content information representing information regarding the first media content being played back on the first channel includes a characteristic of a live broadcast corresponding to the first media content.

In some implementations, the computer program instructions cause the one or more computing devices to determine that the first channel and the second channel have each been selected for playback on the display device for a threshold number range within a threshold time duration, wherein the watched channel information is based on the determination that the first channel and the second channel have each been selected for playback on the display device for the threshold number range within the threshold time duration.

In some implementations, the computer program instructions cause the one or more computing devices to determine activity of a user watching the display device, wherein the watched channel information is based on the determination regarding the activity of the user watching the display device.

Some of the subject matter described herein also includes an electronic device, comprising: a display screen; one or more processors; and memory storing instructions, wherein the processor is configured to execute the instructions such that the processor and memory are configured to: determine that a display device in an environment with an assistant device has played back a first media content selected via a first channel and that the display device has played back a second media content selected via a second channel; provide watched channel information to a server, the watched channel information representing that the display device is switching among the first channel and the second channel to provide playback of the first media content and the second media content; receive media content information from the server, the media content information representing information regarding the first media content being played back on the first channel; generate a first hot button on a graphical user interface (GUI) displayed upon the display screen of the assistant device, the first hot button providing the media content information representing information regarding the first media content; and instruct the display device to switch from playing back the second media content via the second channel to play back the first media content via the first channel based on a selection of the first hot button.

In some implementations, determining that the display device has played back the first media content selected via the first channel and that the display device has played back the second media content selected via the second channel includes identifying infrared (IR) signals generated by a remote control, the IR signals instructing the display device to change channels.

In some implementations, the processor is configured to execute the instructions such that the processor and memory are configured to: receive similar channel information from the server, the similar channel information indicating a third channel providing playback of a third media content similar to one or both of the first media content or the second media content, the third channel not indicated in the watched channel information that represents channels being watched on the display device; and generate a second hot button on the GUI, the second hot button configured to cause the assistant device to instruct the display device to switch playback to the third media content by selecting the third channel.

In some implementations, instructing the display device to switch from playing back the second media content via the second channel to play back the first media content via the first channel based on the selection of the first hot button includes transmitting infrared (IR) signals to the display device, the IR signals representing that the display device should select the first channel.

In some implementations, the processor is configured to execute the instructions such that the processor and memory are configured to: receive graphical content related to similar subject matter of both of the first media content and the second media content; and display the graphical content on the GUI with the first hot button.

In some implementations, the processor is configured to execute the instructions such that the processor and memory are configured to determine that the second channel providing playback is currently selected by the display device for playback, wherein generating the first hot button is based on the determination that the second channel is currently selected by the display device for playback.

In some implementations, the media content information representing information regarding the first media content being played back on the first channel includes a characteristic of a live broadcast corresponding to the first media content.

In some implementations, the processor is configured to execute the instructions such that the processor and memory are configured to determine that the first channel and the second channel have each been selected for playback on the display device for a threshold number range within a threshold time duration, wherein the watched channel information is based on the determination that the first channel and the second channel have each been selected for playback on the display device for the threshold number range within the threshold time duration.

In some implementations, the processor is configured to execute the instructions such that the processor and memory are configured to determine activity of a user watching the display device, wherein the watched channel information is based on the determination regarding the activity of the user watching the display device.

### BRIEF DESCRIPTION OF THE DRAWINGS

FIG. 1 illustrates an example of an assistant device providing a user interface based on the context of the environment.

FIG. 2 illustrates an example of a block diagram providing a user interface based on the context of the environment.

FIG. 3 illustrates an example of a block diagram determining the context of the environment of an assistant device.

FIG. 4 illustrates another example of an assistant device providing a user interface based on the context of the environment.

FIG. 5 illustrates an example of an assistant device.

FIG. 6 illustrates an example of a block diagram for adjusting a user interface to maintain privacy expectations.

FIG. 7 illustrates an example of providing a user interface based on the playback of media content.

FIG. 8 illustrates an example of a block diagram for providing a user interface based on the playback of media content.

### DETAILED DESCRIPTION

This disclosure describes devices and techniques for providing a user interface for a home assistant device based on the context, or characteristics, of its surrounding environment. In one example, the user interface of the home assistant device (e.g., a graphical user interface (GUI) generated for display on a display screen of the home assistant device) can be different based on a combination of contextual factors of the surrounding environment including the person interacting with the home assistant device, the people in the surrounding environment, the time, the location of the home assistant device within the home, the location of the person interacting with the home assistant device, the presence of strangers, interests of the users, etc. As a result, based on the contextual factors, different content (e.g., information, graphical icons providing access to functionality of the home assistant device, etc.) can be displayed by the home assistant device.

Additionally, the same content can be displayed differently. For example, different languages, visual effects, etc. can be provided based on the context of the environment. In another example, two different users (or even the same user at different times) might ask the same question to the home assistant device. Based on differences within the context of the environment when the question is asked, the user interface can provide the same answers to the question differently.

This disclosure also describes devices and techniques for providing a user interface based on playback of media content within the environment. In one example, the home assistant device can determine that a user is switching among different television channels to watch different media content. For example, the user might switch between two different channels of the television using a remote control, each of the different channels providing playback of different media content based on the user's cable television package. When the user switches the channels, the remote control can generate and transmit infrared (IR) light (e.g., using a light-emitting diode (LED)) that can be received by the television (e.g., using a photodiode) to cause it to change channels. The home assistant device can also detect the transmission of IR light as signals (based on pulses of the IR light) indicating the channel that the television is to switch to. Thus, the home assistant device can determine that the user is toggling between the two channels, and provide information regarding the channels that are being watched (i.e., toggled among) to a server. That server can then determine information regarding the channels that are being watched (e.g., if one or both of the two channels is playing back a basketball game, then the teams that are playing, the current score, or other information regarding the media content being played back) and provide that information to the home assistant device. Additionally, information regarding other channels that might be of interest to the user (e.g., other channels that are playing back similar or related content such as another basketball game) can be provided as well.

The home assistant device can then generate “hot buttons” on a GUI providing information regarding the media content played back on channels that are currently not being watched and allowing the user to quickly change the television to that channel. For example, one of the hot buttons can display the score, team names, and time left for a basketball game that is playing back on a channel that the user was previously watching. Thus, the user can be provided information related to the other channels. If the user wants to quickly switch to a channel due to the information provided on the hot button, then the user can quickly and easily select the button (e.g., touch the button on a touchscreen display of the home assistant device), and the home assistant device can transmit the IR signals to the television to emulate the remote control such that the channel can be changed.

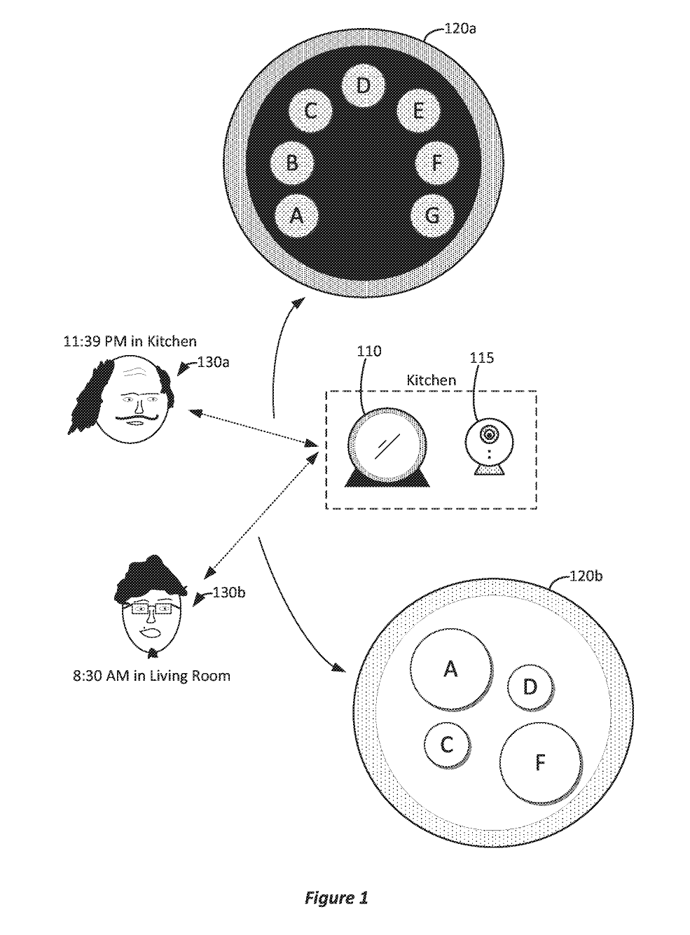

In more detail, FIG. 1 illustrates an example of an assistant device providing a user interface based on the context of the environment. In FIG. 1, home assistant device 110 can include a microphone (e.g., a microphone array) to receive voice input from users and a speaker to provide audio output in the form of a voice (or other types of audio) to respond to the user. Additionally, home assistant device 110 can include a display screen to provide visual feedback to users by generating a graphical user interface (GUI) providing content for display. For example, a user can ask home assistant device 110 a question and a response to that question can be provided on the display screen. Additional visual components, such as light emitting diodes (LEDs), can also be included. As a result, the user interface can include audio, voice, display screens, lighting, and other audio or visual components. In some implementations, camera 115 can also be included for home assistant device 110 to receive visual input of its surrounding environment. Camera 115 can be physically integrated (e.g., physically coupled with) with home assistant device 110 or camera 115 can be a separate component of a home's wireless network that can provide video data to home assistant device 110.

In FIG. 1, home assistant device 110 can be in a particular location of the home, for example, the kitchen. Different users might interact with home assistant device from different locations within the home (e.g., the kitchen or the living room) and at different times. Additionally, the different users might be interested in different features, functionalities, or information provided by home assistant device 110. These different contextual factors of the environment of home assistant device 110 can result in the user interface of home assistant device 110 to be changed. Because the user interface can provide content such as features, functionalities, information, etc., this can result in different content being displayed on the display screen. That is, different combinations of contextual factors of the environment can result in a different user interface of home assistant device 110, resulting in an adaptive user interface based on context of the environment. The contextual factors can also include demographics of the users. For example, if a child is using home assistant device 110 then the content provided can be different than if an adult is using home assistant device 110 (e.g., provide kid-friendly content).

For example, in FIG. 1, user 130a can be in the kitchen (i.e., in the same room or within close proximity with home assistant device 110) at 11:39 PM in the evening. Home assistant device 110 can recognize user 130a, for example, using video input from camera 115 to visually verify user 130a. In another example, home assistant device 110 can recognize user 130a through speech recognition as user 130a speaks either to home assistant device 110, to other people, or even himself. User 130a can also have had previous interactions with home assistant device 110, and therefore, home assistant device 110 can remember the likes or preferences, expectations, schedule, etc. of user 130a. As a result, user interface 120a can be generated for user 130a to interact with home assistant device 110 based on the current context of the environment indicating the user, time, and location that the user is speaking from.

By contrast, user 130b can be in the living room at 8:30 AM of the same home as home assistant device 110. Because the user, time, and location of the user are different, home assistant device 110 can generate a different user interface 120b providing a different GUI having different content as depicted in FIG. 1. As a result, user interface 120b can be different from user interface 120a because they are provided, or generated, in response to different contextual environments when users 130a and 130b speak. This can occur even if the content of the speech provided by users 130a and 130b is similar, or even the same. For example, if both users 130a and 130b ask the same or similar question (e.g., their speech includes similar or same content such as asking for a list of new restaurants that have opened nearby), the user interface (to respond to the question) that is provided by home assistant device 110 can be different because of the different context of the environments when the speech was spoken. Additionally, the users might have different interests (e.g., as indicated by a profile) which can also result in different content providing different services, functionalities, etc.

In another example, because user interface 120a was generated in the evening, it can have different colors, brightness, or other visual characteristics than display 120b. This might be done because the user interface should not be too disruptive in different lighting situations. For example, a light sensor (e.g., a photodiode) can be used to determine that a room is dark. Home assistant device 110 can then adjust the brightness of the display screen based on the determined lighting situation in the environment.

Additionally, because users 130a and 130b are in different rooms and, therefore, at different distances from home assistant device 110, the user interfaces 120a and 120b can be different to take that into account. For example, because user 130a in FIG. 1 is in the kitchen, he may be relatively close to home assistant device 110 and, therefore, the size of some of the content (e.g., items A-G which can be buttons, icons, text, etc.) of a GUI provided as user interface 120a can be relatively small. By contrast, because user 130b is in the living room (i.e., farther away from home assistant device 110 than user 130a), some of the content of user interface 120b can be larger so that they can be more easily seen from a distance. For example, in FIG. 1, icons A and F have different sizes among the different user interfaces 120a and 120b. That is, content such as the items of the user interfaces that provide access to the same functionality or provide an indication to the same type of information can be different sizes because the contextual environments are different. For example, if users 130a and 130b request a listing of new, nearby restaurants, icons A-G might represent a list of some of the identified restaurants. Additionally, the playback of audio can be at a volume based on the distance that a user is from home assistant device 110. For example, a user that is farther away can result in the playback of audio that is at a higher volume than if a user is closer to home assistant device 110.

User interfaces 120a and 120b can also be different in other ways. For example, the location of content, the number of content, etc. as depicted in FIG. 1 can also be different due to the different contextual environments.

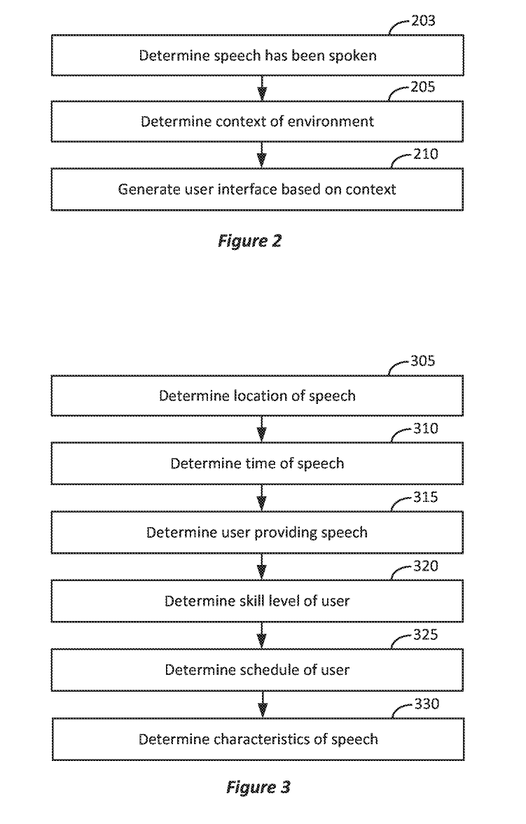

FIG. 2 illustrates an example of a block diagram providing a user interface based on the context of the environment. In FIG. 2, at block 203, speech can be determined to have been spoken. For example, a microphone of home assistant device 110 can pick up speech spoken within the environment. That speech can be converted into voice data and analyzed by a processor of home assistant device 110 to determine that speech has been received. At block 205, the context of the surrounding environment or vicinity around home assistant device 110 can be determined. For example, home assistant device 110 can determine any of the aforementioned details regarding the environment in the physical space around home assistant device 110 including time, user, prior interactions with the user, locations of the user and home assistant device 110, etc. Any of the details discussed below can also be determined. At block 210, the user interface can be provided or generated based on the determined context and content of the speech. For example, this can include generating a GUI with content related to the content of the speech and provided at various sizes, colors, etc. on a display screen of home assistant device 110 based on the context. In some implementations, the user interface can also include playback of audio (e.g., sounds), turning on various lighting effects (e.g., LEDs), etc. For example, different GUIs with different audio effects can be provided.

Next, home assistant device 110 can pick up more speech at a different time. However, if the context of the environment is different, then a different user interface than that generated at block 210 can be generated. Thus, even if the content of the speech at the two different times was the same, the user interfaces generated can be different if the context of the environment was different.

FIG. 3 illustrates an example of a block diagram determining the context of the environment of an assistant device. In FIG. 3, as previously discussed, the location of the speech can be determined at block 305, the time of the speech can be determined at block 310, and the user providing speech can be determined at block 315 to determine the context of the environment.

Other details can include the skill level of the user at block 320. For example, home assistant device 110 can determine the skill level of a user as they interact more with the user interface. If the user uses more functionality, more complicated functionality, requests significant amount of detail regarding functionality, etc. then the user can be identified by home assistant device 110 as a more sophisticated user. By contrast, if another user tends to ask the same repetitive tasks or questions of home assistant device 110 then the user can be identified as a less sophisticated user. If the user tends to use less complicated functionality, less functionality, or does not request significant detail, then the user can also be identified as a less sophisticated user. In FIG. 1, user 130a can be a more sophisticated user indicating that the user has a relatively high skill level in using home assistant device 110, and therefore, more functionality (or content) can be provided on user interface 120a (i.e., items A-G are provided). By contrast, user 130b can be a less sophisticated user indicating that the user has a relatively lower skill level (than user 130a), and therefore, less content can be provided on user interface 120b (i.e., fewer items A, C, D, and F are provided). In some implementations, the same number of content of user interfaces might be provided, but different content corresponding to different functionalities or features might be displayed based on the skill level of the user. Thus, different content can be provided in a user interface of home assistant device 110.

As previously discussed, the user interface can include other visual components other than displaying content as part of a GUI on a display screen. In FIG. 1, this can include lighting, for example, LEDs or other types of lights which can be activated by being turned on, glow, flicker, display a particular color, etc. to provide an indication to a user of a situation. For example, home assistant device 110 can determine a user's schedule at block 325 and provide an indication as to when the user should be leaving the home so that they can maintain that schedule without any tardiness. In FIG. 1, this can result in a ring around the display screen that can be different colors (e.g., implemented with LEDs or other types of lighting), however in other implementations the ring can be part of the display screen itself.

In one example, the ring can be a color corresponding to the traffic or commute status for the user to go to their next expected location, such as the workplace in the morning or a coffee meeting scheduled on their calendar. If the ring is set to a green color, then this can indicate to the user that the traffic is relatively light. By contrast, a red color can indicate that the traffic is relatively heavy. This type of user interface can provide a user with information while they are far away from home assistant device 110 because the colors can be easily seen from a distance. In some implementations, the ring can also indicate whether the user needs to leave soon or immediately if they want to make the next appointment on their schedule. For example, the intensity or brightness of the color can be increased, the ring can be blinking, etc. This can provide further detail from a distance for a user. In some implementations, the user interface can also display on the display screen a route to the location of the next event on their schedule, provide a time estimate, etc. As a result, if the user decides that they want more detail and walks closer to home assistant device 110, information can be readily displayed and available. In some implementations, home assistant device 105 can determine that the user is walking closer after the ring has been activated and then process information and display the additional information on the display screen so that information is available when they are closer. In some implementations, the color of the ring can indicate other determinations, for example, an unexpected situation such as a window or door being open, water flooding detected, or the temperature is within a temperature range corresponding to an anomaly.

The user interface can also include audio sounds for playback. For example, user interface 120a in FIG. 1 might play back one type of audio sound when user 130a interacts with it, for example, selecting one of the items A-G, requesting user interface 120a to change (e.g., provide new content), etc. By contrast, user interface 120b might play back different sounds for the same interactions by user 130b because of the different context of the environment.

Characteristics regarding the speech received by home assistant device 110 can also be determined at block 330. For example, home assistant device 110 can determine the volume, speed, accent, language, tone, etc. of speech and use that as a contextual factor in providing a user interface. In one example, if a user is speaking quickly (e.g., at a speed or rate determined to be within a words per minute range corresponding to speaking quickly), then content of the user interface may be updated faster than if the user was speaking slowly, for example, by updating the GUI of the user interface sooner. In another example, if the user's speech is determined to be indicative of stress or frustration, then the user interface might provide content differently than if the user's speech is determined to be relatively free of stress or frustration. As an example, if the user is stressed or frustrated, then the amount of content provided on the user interface can be reduced in comparison with the user not being stressed or frustrated.

In some implementations, if the user is determined to be stressed or frustrated, then the user interface can include the playback of music. For example, calming music can be played back using the speaker of home assistant device 110.

In some implementations, the lighting of home assistant device 110 can be different based on what is provided on the user interface. For example, different types of content can result in different brightness, colors, etc.

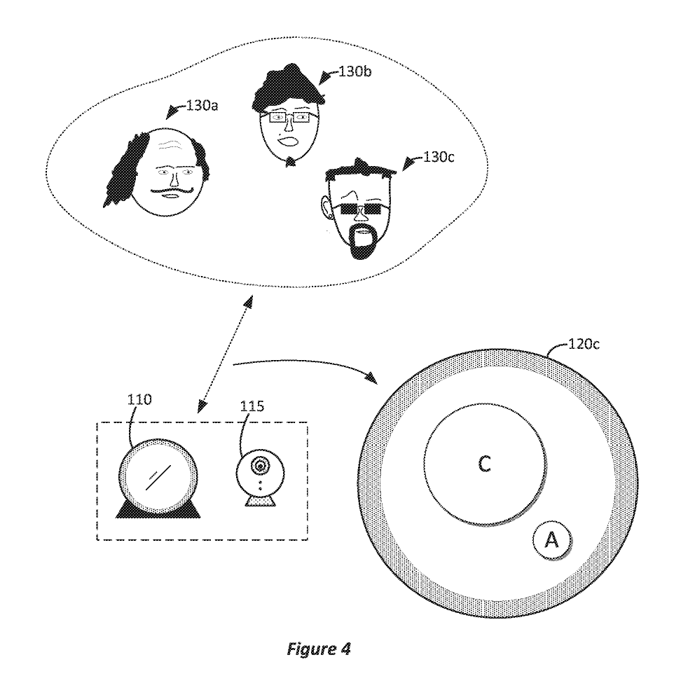

The user interface can also be changed to account for privacy expectations of a user when the context of the environment changes (i.e., the conditions or characteristics of the environment change). FIG. 4 illustrates another example of an assistant device providing a user interface based on the context of the environment. In FIG. 4, users 130a, 130b, and 130c are within the home environment of home assistant device 110. These different users can be identified and the user interface 120c in FIG. 4 can be generated to take into account privacy concerns of the various users.

For example, user 130a might want some content to be provided on a user interface if he is alone, but might not want that content to be displayed if others are within the home. Likewise, user 130b also might not want some content to be provided. In some implementations, user 130a might find it acceptable to have the content provided on the user interface even if the presence of user 130b is detected because user 130b is a member of the same household. However, user 130a might want that content to not be displayed if strangers or guests are in the home. User 130c can be a stranger or newcomer into the home environment and has never interacted with home assistant device 110 and therefore, is unrecognized by home assistant device 110.

Home assistant device 110 can recognize the different users or persons within the home and generate user interface 120c based on the users 130a-c. For example, home assistant device 110 can take some details of user interfaces 120a and 120b (e.g., user interfaces normally for users 130a and 130b, respectively) and generate user interface 120c in FIG. 4 based on those other user interfaces. That is, user interface 120c can be generated based on how user interfaces would be generated for users 130a and 130b. In FIG. 4, this results in some content of user interface 120b having a relatively large size (e.g., as in user interface 120b), but less content than either user interfaces 120a or 120b. In some implementations, content that would mutually exist in user interfaces 120a and 120b can be provided within user interface 120c, but content that is only on one of user interfaces 120a and 120b might not be provided because it might only appeal to a single user or those users might have different privacy expectations. For example, item B as depicted in user interface 120a in FIG. 1 might not appear because it is not provided within user interface 120b in FIG. 1.

In some implementations, upon detection of user 130c (i.e., a stranger or guest in the environment), the user interface can also be adapted to take into account an unrecognized user. For example, upon detection of an unrecognized user, some content might be removed from a user interface. When the unrecognized user leaves, this can be detected, and therefore, home assistant device 110 can then provide the removed content back with the user interface. As a result, the user's privacy expectations can be maintained when guests are nearby.

Other types of changes in context of the environment other than detection of strangers or guests can include determining differences in time. For example, a user might find it acceptable to display some content on the GUI late at night or early in the morning, but might not want that content displayed during the daytime because the likelihood of others seeing that content might be higher. Another example can include activities of persons within the environment. For example, if several people in the environment are discussing a particular topic, a social gathering is taking place, etc. then perhaps a user's privacy expectations can be elevated and, therefore, some of the content that would otherwise be displayed can be removed.

In some implementations, a user's privacy expectations can be set by that user or learned by home assistant device 110 over time, or a combination of both. For example, the user can indicate that certain content should not be displayed when unrecognized persons are in the environment. As another example, the user might remove content from the GUI and home assistant device 110 can identify the context in the environment when the user removed the content to determine the user's privacy expectations.

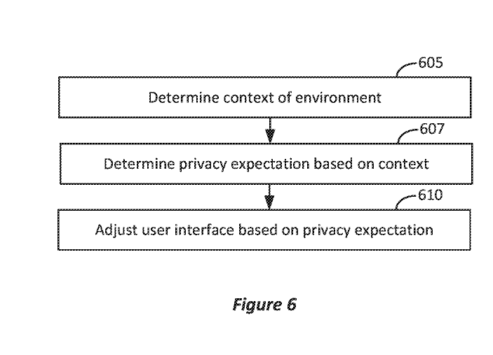

FIG. 6 illustrates an example of a block diagram for adjusting a user interface to maintain privacy expectations. In FIG. 6, at block 605, the context of the environment can be determined. For example, the presence of persons including recognized users and/or strangers, the time, activities being performed in the environment, etc. can be determined. At block 607, privacy expectations for a user based on the context can be determined. For example, if a user is within the environment, a GUI providing various content can be provided. However, if strangers or guests are detected within the environment, the user might not want certain content displayed on the GUI due to an increase in privacy concerns resulting in higher privacy expectations for that content. Thus, at block 610, the GUI can be adjusted or modified based on the privacy expectations. For example, the content can be removed due to the increase in privacy expectations while the stranger or guest is present within the environment.

When the stranger or guest leaves, this can be determined as a change in the context of the environment and, therefore, also a change in the privacy expectations for the user. Because the user might be the only person within the environment, the GUI can be modified again to include the content that was previously removed. Thus, if the context of the environment changes and, therefore, the user for whom the GUI is provided has a change in privacy expectations, then the GUI can be adapted.

Many of the examples disclosed herein discuss visual adaptations for the user interface. However, audio adaptations can also be performed based on the context situations described above. For example, the type of voice, accent, volume, etc. can also be adjusted for different user interfaces using the techniques described herein.

Many of the examples disclosed herein discuss speech being recognized. However, other types of audio can also be used with the techniques. For example, noise from objects such as television or radio, a doorbell ringing, a door opening, glass shattering, etc. can also be detected occurrences of activity other than speech.

In some implementations, the content of the user interface can also be changed based on whether or not it is determined that a user is looking at home assistant device 110 or speaking to home assistant device 110. For example, the display screen of home assistant device 110 might be turned off, but can turn on when it is determined that a user is looking at it.

In some implementations, the volume of playback of audio provided by home assistant device 110 can be adjusted (e.g., lowered) upon detection of an incoming phone call or page (e.g., via a mobile phone within the home environment). In another example, the content displayed can be adjusted based on the status of another device. For example, a recipe displayed on the display screen of home assistant device 110 can be changed based on determined statuses of a kitchen appliance (e.g., oven, timer, etc.) used for the recipe.

In some implementations, the content provided via the user interface can be based on how a user is using another device within the home. For example, the infrared signals of a television and/or remote control of the television can be detected to indicate which channels are being switched among. This information can be provided to a cloud server by home assistant device 110, which can provide home assistant device 110 with information regarding the media content on those channels being watched. For example, the media content to be provided via the user interface can include “hot buttons” that can show information regarding the channels (e.g., schedule, current programming, popularity ratings for what is currently being played on the channel, etc.). In another example, if a channel is determined to be playing a sports game, then the score, team information (e.g., team rosters) can be displayed. In some implementations, if the user is determined to be switching between three channels within a short period of time and repeating some of the channels during that short period of time (e.g., each channel is visited at least twice in a five minute period), then hot buttons can be generated for each of those channels. The hot buttons can be displayed in different parts of the display screen and each button can include content representing information corresponding to the channel. For example, the user can be switching between three channels playing three different basketball games. Each of the hot buttons can include the scores and time (e.g., 3:23 left in the fourth quarter) of the game played on that channel. Thus, switching between the different channels can be determined and content for the channels that aren't even being watched can be displayed via the hot buttons. The user can then select one of those buttons and the television can switch to the channel corresponding to the selected button. This can be done with home assistant device 110 communicating with the television either via the wireless network or by generating infrared signals to simulate a remote control.

In more detail, home assistant device 110 can be placed within the home where it is easily accessible to users and the user interface displayed on its display screen is easily seen. For example, some users might place home assistant device 110 in the living room where they also watch media content played back on their television, engage in social activities, etc. Thus, home assistant device 110 might be placed on a coffee table or end table in the living room where it is close to where people are engaged in a variety of activities in the home. In some implementations, home assistant device 110 can determine information regarding the playback of media content on the television (or other display device such as a computer monitor, tablet, smartphone, etc.) and then generate content for its user interface based on the playback of the media content.

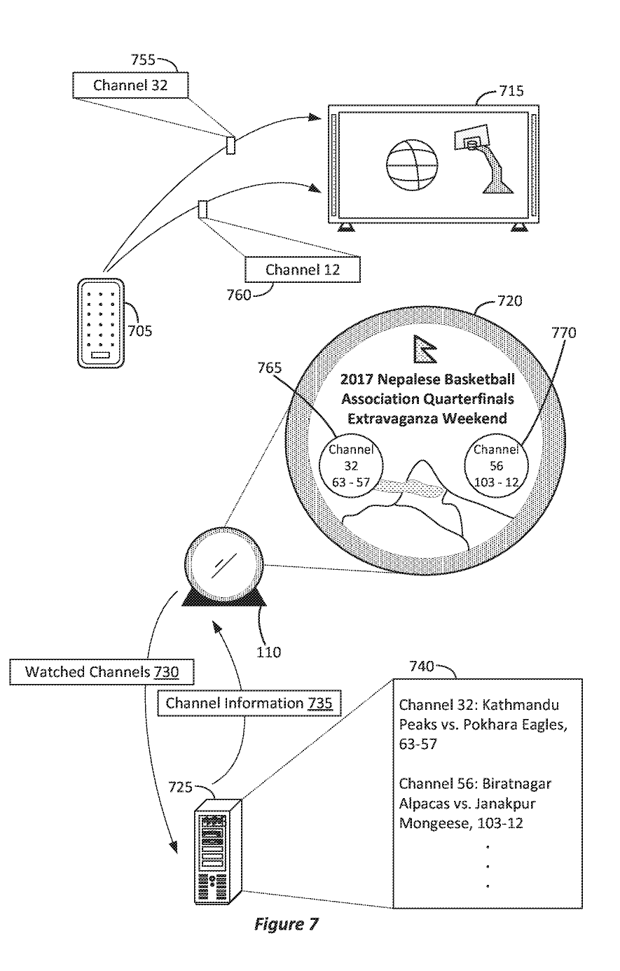

FIG. 7 illustrates an example of providing a user interface based on the playback of media content. In FIG. 7, a user might select buttons on remote control 705 to change the channel being played back on television 715. For example, the user might first use remote control 705 to turn on television 715, and then select one or more buttons such that IR light 755 indicating that television 715 is to switch to channel 32 is generated by remote control 705. In FIG. 7, channel 32 might be playing a basketball game. During a time out or commercial break, the user might want to switch to another channel to watch another basketball game. Thus, in FIG. 7, the user can use remote control 705 to generate IR light 760 indicating that television 760 should switch to channel 12, which is a different channel providing playback of another basketball game (i.e., playback of different media content). The different channels can be different sources of media content, for example, different sources of live playback provided by different television stations.

In FIG. 7, home assistant device 110 can include a photodiode or other type of circuitry to determine that IR light 755 and 760 were generated by remote control 705. By keeping track of the IR signals corresponding to IR light 755 and 760 (e.g., by storing data in a database indicating the channels being switched to), home assistant device 110 can determine which channels that the user is watching (e.g., channels 12 and 32 in FIG. 7). For example, if the user is switching between the two channels several times within a time duration (e.g., switching channel 12-to-32 and channel 32-to-12 are performed among a threshold number of times within a threshold time duration, such as at least four times within twenty minutes), then home assistant device 110 can determine that the user is interested in the media content being played back on both of those channels. Home assistant device 110 can provide watched channels information 730 indicating that the user is watching channels 12 and 32, as well as other information such as the type of cable provider to server 725.

Server 725 can be a cloud server that tracks information regarding the media content being played back on channels. For example, server 725 can receive or generate real-time information regarding the media content being played back on different channels. If channels 12 and 32 are playing back different basketball games (or other types of sports), then server 725 can store information indicating the teams playing, the time left in the game or portion of the game (e.g., how much time is left in a period or quarter), the score, team logos, team records (e.g., wins, losses, ties), etc. Other types of media content can include different types of information. For example, if a movie is being played back on another channel, then ratings, reviews, box office revenue, time left to finish playback of the movie, actors and actresses starring in the movie, director and/or other filmmaker credits, etc. can be stored by server 725. In FIG. 7, channel information database 740 of server 725 can store the information regarding the media content being played back on different channels.

If server 725 receives watched channels information 730, then it can provide channel information 735 using information from channel information database 740. For example, if channels 12 and 32 are playing back different basketball games, then the information indicated above (e.g., scores, etc.) can be provided to home assistant device 110. Home assistant device 110 can then generate content on user interface 720 displayed upon its display screen using that information. Thus, characteristics of a live broadcast (e.g., the score of a live basketball game) can be provided to home assistant device 110 to be depicted upon its display screen.

For example, in FIG. 7, television 715 might currently play back media content provided on channel 12. Home assistant device 110 can determine this (e.g., by keeping track of IR light 755, 760 as discussed previously) and then generate and display hot button 765 using channel information 735 regarding channel 32. That is, one of the channels that the user was determined to be switching among (e.g., channel 32) can be currently not playing back on television 715 and information regarding that channel can be displayed using user interface 720. For example, in FIG. 7, hot button 765 includes a channel number and a score of a basketball game being played back on that channel. However, any other information from channel information 735 and obtained from channel information database 740 can be generated (e.g., team names, graphical logos, etc.) as well. Thus, hot button 765 indicates that the user was previously watching channel 32. Channel information 735 can be provided periodically (e.g., every 1 second, every 1 minute, etc.) and the information displayed upon hot button 765 can be updated to reflect changes or activities going on in the media content being played back on that channel while the user is watching another channel. For example, the score of the basketball game being played back on channel 32 can be updated as it changes. If the user is currently watching channel 12 and the information displayed on hot button 765 seems like that other basketball game is getting more exciting, then the use can quickly and easily switch from channel 12 to channel 32 by selecting hot button 765. Home assistant device 110 can then generate an IR signal using IR light pulses similar to remote control 705 to cause television 715 to change to channel 32. This can result in channel 32 then being displayed on television 715, and a new hot button providing information regarding the basketball game on channel 12 being generated and displayed on user interface 720. In other implementations, home assistant device 110 might provide the signal to remote control 705 and instruct it to cause television 715 to change channels accordingly. In another implementations, home assistant device 110 and television 715 might be communicatively coupled with each other via a wireless network and communicate with that rather than via IR light.

The user might also not be aware of other channels providing playback of media content that they might be interested in. For example, the user might be watching the basketball games being played back on channels 12 and 32. However, those basketball games might be part of a larger basketball tournament and other games related to that tournament might be playing back on other channels. Server 725 can determine this (e.g., by determining similarities in the media content being played back on the different channels) and include information regarding those other channels in channel information 735. For example, as depicted in FIG. 7, channel 56 as indicated in channel information database 740 is playing back another basketball game. Thus, server 725 can include this information in channel information 735 and provide it to home assistant device 110. Home assistant device 110 can then generate hot button 770 indicating that channel 56 has another game available for watching on television 715. Thus, even though the user was switching among channels 12 and 32, the user can be recommended to expand the selection of channels they are watching to include channel 56 because it is playing another basketball game. Additionally, information regarding that game (e.g., the score) can be displayed upon hot button 770. This can provide the user with some information regarding what is being played back on that other channel and, therefore, they can decide whether to switch to it.

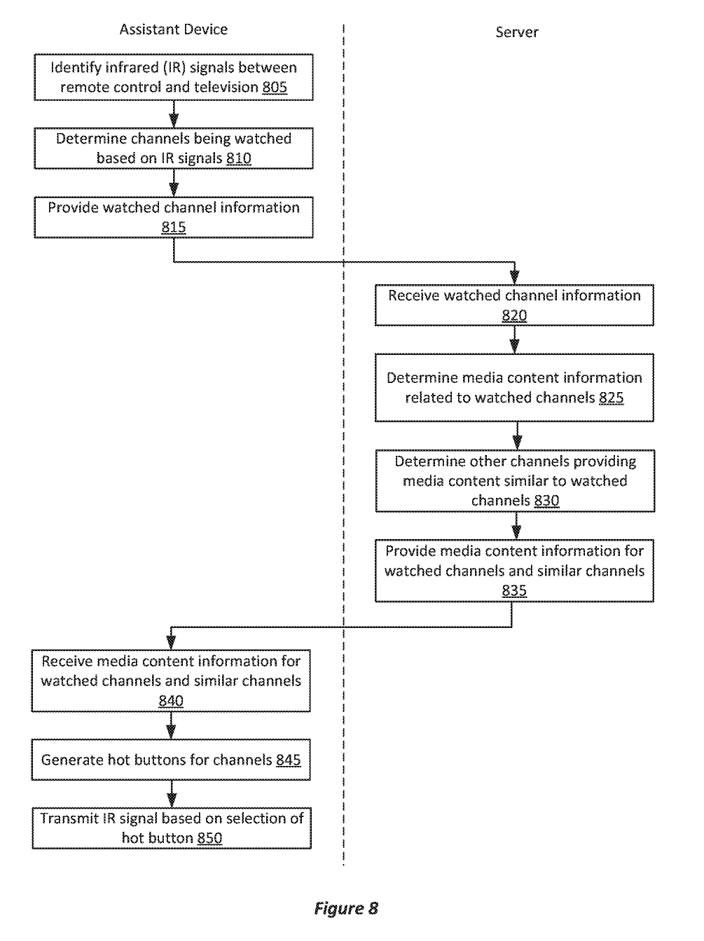

FIG. 8 illustrates an example of a block diagram for providing a user interface based on the playback of media content. In FIG. 8, IR signals transmitted by a remote control to a television can be identified (805). For example, as discussed regarding FIG. 7, IR light 755 and 760 can be received by home assistant device 110 such that it can determine which channels are being watched using television 715.

The channels being watched can be determined based on the IR signals (810). For example, in FIG. 7, home assistant device 110 can determine the type of television of television 715 (e.g., brand, model number, etc.). Different IR signals can be used by different remote controls and televisions. Thus, the channels being watched can be identified. Additionally, channels can be indicated as being watched based on characteristics of the user's television watching habits. For example, some users might be “channel surfing” in which they are constantly switching through channels (e.g., ascending upwards through the channels from 1 to 2, 2 to 3, etc.). However, eventually, the user might select only a handful of channels to switch among. Those channels can be identified as channels being watched.

In some implementations, the channels can be identified based on how often the user is switching among the channels within a time duration (e.g., a particular channel is watched or switched to a threshold number of times within a threshold time duration, such as four times in twenty minutes). If the user is switching among five channels within the time duration, then those five channels can be identified as channels being watched. In other implementations, if the IR signals are for specific channels (e.g., indicating to television 715 in FIG. 7 to switch to channel 12 rather than merely switching through a channel list such as from channel 11 to channel 12 to channel 13, etc.) then those specific channels can be the identified channels.

In another implementation, the user's speech can be detected, for example, using microphones of home assistant device 110. If the user is determined to be talking regarding the media content (e.g., the subject that is the target of the media content) of the channel, then the channel can be one of the identified channels. This might be done because if the user is discussing the media content being played back, then they might be interested in watching that channel. In another example, the user's activity can be detected using video cameras to generate image frames of the environment depicting what the user is doing while watching the channels. If the user is perceived (via image recognition algorithms) to be staring at the television for a time period (e.g., for at least thirty seconds), then the channel being played can be an identified channel. If the user is not staring at the television for at least that time period, then that channel might not be of interest to the user. Other visual characteristics of the user can also be identified. For example, if the user or others in the environment are wearing attire or holding paraphernalia such as a cap, jersey, flag, etc. indicating a sports team, then that can be recognized (including the sports team in some implementations) and be used to identify channels playing games related to that sport.

In another implementation, characteristics of the channel or the media content played back on that channel can be used. For example, channels can be marked as favorites by a user, indicating that they are channels that the user prefers to watch and, therefore, should be identified as being watched. The type of content being played back can also be determined. For example, news, sports, or other programming or media content that are generally played back in real-time (i.e., currently ongoing) can be identified as a watched channel if the user selects it.

The watched channel information can then be provided to a server (815). For example, in FIG. 7, watched channel information 730 can be provided to server 725. The server can receive the watched channel information (820) and then determine media content information related to the watched channels indicated in the watched channel information (825).

For example, in FIG. 7, the channels being watched by the user can be detailed via watched channel information 730. The channels being watched can be looked up in channel information database 740 by server 725 to determine information regarding the media content being played back on the channel, for example, a score of a sports game if the media content is a sports game.

Additionally, other channels providing media content similar to the media content of the watched channels (i.e., identified channels) can be determined (830). For example, server 725 can determine the type of media content being played back (e.g., news, sports, a movie, a comedy television show, stand-up comedy routine, etc.), people acting in the media content, the director or filmmaker of the media content, or other characteristics of the media content itself to identify similar media content currently being played back on other channels (e.g., as indicated in channel information database 740). As previously discussed, these other channels might be of interest for the user to watch. The media content information for the watched channels and the similar channels can then be provided (835) to the home assistant device (840).

The home assistant device can then generate hot buttons for the channels on the user interface displayed upon the display screen of the home assistant device (845). For example, home assistant device 110 in FIG. 7 can determine which channel is currently playing on television 715 (e.g., by keeping track of the IR signals and determining that the last channel switched to based on the IR signals is the currently played back channel) and then generate hot buttons for the other channels that are not being played back. For example, in FIG. 7, hot button 765 can be generated for a channel that the user was previously watching and hot button 770 can be generated for a channel that the user was not watching but might be interested in watching (as determined by server 725, as previously discussed) because the media content being played back there is similar to the media content currently on the channel being played back on television 715.

If the user selects one of the hot buttons, then this can be determined (e.g., by detecting touches on the touchscreen that are at coordinates corresponding to the position of the hot button) and the home assistant device can generate or transmit an IR signal for the television to switch the channel based on the selected hot button. For example, in FIG. 7, if the user selects hot button 770, then home assistant device 110 can generate an IR signal to be received by television 715 instructing it to switch to channel 56. Thus, the user can use home assistant device 110 to easily and quickly switch the channels played back on television 715.

In some implementations, server 725 in FIG. 7 can also provide graphical content to be displayed with UI 720. For example, if server 725 determines similarities between the channels, then it can provide a graphic to home assistant device 110 to display with the hot buttons 765 and 770. For example, if the user is switching between several different basketball games provided via different channels, each of those basketball games might be games of a larger basketball tournament. To help contribute to the atmosphere of watching the tournament, server 725 can provide text or graphical content as a theme to be displayed upon the display screen of home assistant device 110 to advertise that tournament. For example, in FIG. 7, the background graphic depicts the name and other related graphics identifying the tournament in which the different channels are providing playback of its games.

Any of the techniques described elsewhere herein can also be used for the content (e.g., hot buttons, etc.). For example, different users might result in different sizes of hot buttons, positions of hot buttons, number of hot buttons, etc. In another example, hot buttons for channels that the user was identified as watching can be a different size (e.g., larger) than other channels recommended by server 725.

Additionally, the techniques describe switching among different channels of a television. However, switching among different streaming media content can also be performed using similar techniques.

Many of the aforementioned examples discuss a home environment. In other examples, the devices and techniques discussed herein can also be set up in an office, public facility, etc.

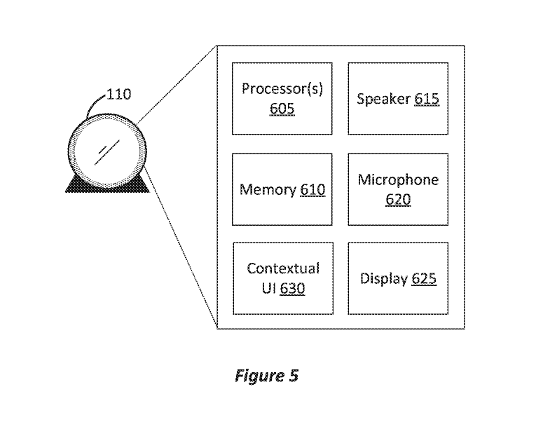

FIG. 5 illustrates an example of an assistant device. In FIG. 5, home assistant device 110 can be an electronic device with one or more processors 605 (e.g., circuits) and memory 610 for storing instructions that can be executed by processors 605 to implement contextual user interface 630 providing the techniques described herein. Home assistant device 105 can also include microphone 620 (e.g., one or more microphones that can implement a microphone array) to convert sounds into electrical signals, and therefore, speech into data that can be processed using processors 605 and stored in memory 610. Speaker 615 can be used to provide audio output. Additionally, display 625 can display a GUI implemented by processors 605 and memory 610 to provide visual feedback. Memory 610 can be a non-transitory computer-readable storage media. Home assistant device 110 can also include various other hardware, such as cameras, antennas, etc. to implement the techniques disclosed herein. Thus, the examples described herein can be implemented with programmable circuitry (e.g., one or more microprocessors) programmed with software and/or firmware, or entirely in special-purpose hardwired (non-programmable) circuitry, or in a combination of such forms. Special-purpose hardwired circuitry may be in the form of, for example, one or more application specific integrated circuits (ASICs), complex programmable logic devices (CPLDs), field programmable gate arrays (FPGAs), structured ASICs, etc.

Those skilled in the art will appreciate that the logic and process steps illustrated in the various flow diagrams discussed herein may be altered in a variety of ways. For example, the order of the logic may be rearranged, sub-steps may be performed in parallel, illustrated logic may be omitted, other logic may be included, etc. One will recognize that certain steps may be consolidated into a single step and that actions represented by a single step may be alternatively represented as a collection of substeps. The figures are designed to make the disclosed concepts more comprehensible to a human reader. Those skilled in the art will appreciate that actual data structures used to store this information may differ from the figures and/or tables shown, in that they, for example, may be organized in a different manner; may contain more or less information than shown; may be compressed, scrambled and/or encrypted; etc.

From the foregoing, it will be appreciated that specific embodiments of the invention have been described herein for purposes of illustration, but that various modifications can be made without deviating from the scope of the invention. Accordingly, the invention is not limited except as by the appended claims.

1. A method for providing a graphical user interface (GUI) on a touchscreen of a home assistant device with artificial intelligence (AI) capabilities, the GUI providing content related to playback of media content within an environment of the home assistant device, comprising:
identifying infrared (IR) signals generated by a remote control and directed to a display device configured to provide playback of media content;
determining that the IR signals represent that the display device should play back a first media content by selecting a first channel and that the display device should play back a second media content by selecting a second channel, the first channel and the second played back at different times, the first channel and the second channel being different sources of live playback of media content;
generating image data representing a user watching the play back of the first media content and the second media content;
determining visual characteristics regarding the user based on the image data;
determining watched channel information based on the IR signals and the visual characteristics of the user;
providing the watched channel information to a server, the watched channel information representing that the first channel and the second channel are being watched by the user on the display device within the environment of the home assistant device;
receiving media content information from the server, the media content information representing information regarding the first media content being played back on the first channel and regarding the second media content being played back on the second channel, the media content information indicating that the first media content and the second media content are providing playback of sports games and providing information regarding scores of the sports games being played back on the first channel and the second channel;
receiving similar channel information from the server, the similar channel information indicating a third channel providing playback of a third media content similar to one or both of the first media content or the second media content, the third channel not indicated in the watched channel information that represents channels being watched on the display device;
determining that the first channel providing playback of the first media content is currently selected by the display device for playback of the first media content;
generating a first hot button for display on the GUI of the touchscreen of the home assistant device based on the determination that the first channel is currently selected by the display device for playback of the first media content, the first hot button providing detail regarding a first score of the sports game being played back on the first channel;
generating a second hot button for display on the GUI of the touchscreen of the home assistant device based on the determination that the first channel is currently selected by the display device for playback of the first media content, the second hot button providing detail regarding a second score of the sports game being played back on the third channel;
determining that the first hot button or the second hot button was selected via a touch on the touchscreen of the home assistant device; and
transmitting an IR signal representing that the display device should switch from playing back the first media content on the first channel to playing back the media content corresponding to the channel associated with the first hot button or the second hot button that was selected.

2. A method, comprising:
determining, by a processor of an assistant device, that a display device in an environment with the assistant device has played back a first media content selected via a first channel and that the display device has played back a second media content selected via a second channel;
determining characteristics regarding a user in the environment watching one or both of the first media content or the second media content;
determining watched channel information based on the characteristics of the user and the determination that the display device has played back the first media content and the second media content;
providing watched channel information to a server, the watched channel information representing that the display device is switching among the first channel and the second channel to provide playback of the first media content and the second media content;
receiving media content information from the server, the media content information representing information regarding the first media content being played back on the first channel;
generating, by the processor, a first hot button on a graphical user interface (GUI) displayed upon a display of the assistant device, the first hot button providing the media content information representing information regarding the first media content; and
instructing the display device to switch from playing back the second media content via the second channel to play back the first media content via the first channel based on a selection of the first hot button.

3. The method of claim 2, wherein determining that the display device has played back the first media content selected via the first channel and that the display device has played back the second media content selected via the second channel includes identifying infrared (IR) signals generated by a remote control, the IR signals instructing the display device to change channels.

4. The method of claim 2, further comprising:
receiving similar channel information from the server, the similar channel information indicating a third channel providing playback of a third media content similar to one or both of the first media content or the second media content, the third channel not indicated in the watched channel information that represents channels being watched on the display device; and
generating a second hot button on the GUI, the second hot button configured to cause the assistant device to instruct the display device to switch playback to the third media content by selecting the third channel.

5. The method of claim 2, wherein instructing the display device to switch from playing back the second media content via the second channel to play back the first media content via the first channel based on the selection of the first hot button includes transmitting infrared (IR) signals to the display device, the IR signals representing that the display device should select the first channel.

6. The method of claim 2, further comprising:
receiving graphical content related to similar subject matter of both of the first media content and the second media content; and
displaying the graphical content on the GUI with the first hot button.

7. The method of claim 2, further comprising:
determining that the second channel providing playback is currently selected by the display device for playback, wherein generating the first hot button is based on the determination that the second channel is currently selected by the display device for playback.

8. The method of claim 2, wherein the media content information representing information regarding the first media content being played back on the first channel includes a characteristic of a live broadcast corresponding to the first media content.

9. The method of claim 2, further comprising:
determining that the first channel and the second channel have each been selected for playback on the display device for a threshold number range within a threshold time duration, wherein the watched channel information is based on the determination that the first channel and the second channel have each been selected for playback on the display device for the threshold number range within the threshold time duration.

10. The method of claim 2, further comprising:
determining activity of a user watching the display device, wherein the watched channel information is based on the determination regarding the activity of the user watching the display device.

11. A computer program product, comprising one or more non-transitory computer-readable media having computer program instructions stored therein, the computer program instructions being configured such that, when executed by one or more computing devices, the computer program instructions cause the one or more computing devices to:
determine that a display device in an environment with an assistant device has played back a first media content selected via a first channel and that the display device has played back a second media content selected via a second channel;
receive audio data representing speech provided by a user in the environment watching one or both of the first media content or the second media content;
determine watched channel information based on the audio data of the user and the determination that the display device has played back the first media content and the second media content;
provide watched channel information to a server, the watched channel information representing that the display device is switching among the first channel and the second channel to provide playback of the first media content and the second media content;
receive media content information from the server, the media content information representing information regarding the first media content being played back on the first channel;
generate a first hot button on a graphical user interface (GUI) displayed upon a display of the assistant device, the first hot button providing the media content information representing information regarding the first media content; and
instruct the display device to switch from playing back the second media content via the second channel to play back the first media content via the first channel based on a selection of the first hot button.

12. The computer program product of claim 11, wherein determining that the display device has played back the first media content selected via the first channel and that the display device has played back the second media content selected via the second channel includes identifying infrared (IR) signals generated by a remote control, the IR signals instructing the display device to change channels.

13. The computer program product of claim 11, the computer program instructions cause the one or more computing devices to:
receive similar channel information from the server, the similar channel information indicating a third channel providing playback of a third media content similar to one or both of the first media content or the second media content, the third channel not indicated in the watched channel information that represents channels being watched on the display device; and
generate a second hot button on the GUI, the second hot button configured to cause the assistant device to instruct the display device to switch playback to the third media content by selecting the third channel.

14. The computer program product of claim 11, wherein instructing the display device to switch from playing back the second media content via the second channel to play back the first media content via the first channel based on the selection of the first hot button includes transmitting infrared (IR) signals to the display device, the IR signals representing that the display device should select the first channel.

15. The computer program product of claim 11, the computer program instructions cause the one or more computing devices to:
receive graphical content related to similar subject matter of both of the first media content and the second media content; and
display the graphical content on the GUI with the first hot button.

16. The computer program product of claim 11, the computer program instructions cause the one or more computing devices to:
determine that the second channel providing playback is currently selected by the display device for playback, wherein generating the first hot button is based on the determination that the second channel is currently selected by the display device for playback.

17. The computer program product of claim 11, wherein the media content information representing information regarding the first media content being played back on the first channel includes a characteristic of a live broadcast corresponding to the first media content.

18. The computer program product of claim 11, the computer program instructions cause the one or more computing devices to:
determine that the first channel and the second channel have each been selected for playback on the display device for a threshold number range within a threshold time duration, wherein the watched channel information is based on the determination that the first channel and the second channel have each been selected for playback on the display device for the threshold number range within the threshold time duration.

19. The computer program product of claim 11, the computer program instructions cause the one or more computing devices to:
determine activity of a user watching the display device, wherein the watched channel information is based on the determination regarding the activity of the user watching the display device.

20. An electronic device, comprising:
a display screen;
one or more processors; and
memory storing instructions, wherein the processor is configured to execute the instructions such that the processor and memory are configured to:
determine that a display device in an environment with an assistant device has played back a first media content selected via a first channel and that the display device has played back a second media content selected via a second channel;
receive image data representing a user watching the play back of the first media content and the second media content;
determine that the user watched the first media content for a time duration within a threshold time duration and that the user watched the second media content for a time duration within the threshold time duration based on the image data;
determine watched channel information based on the determination that the first media content and the second media content were watched for the time durations within the threshold time duration and the determination that the display device has played back the first media content and the second media content;
provide watched channel information to a server, the watched channel information representing that the display device is switching among the first channel and the second channel to provide playback of the first media content and the second media content;
receive media content information from the server, the media content information representing information regarding the first media content being played back on the first channel;
generate a first hot button on a graphical user interface (GUI) displayed upon the display screen of the assistant device, the first hot button providing the media content information representing information regarding the first media content; and
instruct the display device to switch from playing back the second media content via the second channel to play back the first media content via the first channel based on a selection of the first hot button.

21. The electronic device of claim 20, wherein determining that the display device has played back the first media content selected via the first channel and that the display device has played back the second media content selected via the second channel includes identifying infrared (IR) signals generated by a remote control, the IR signals instructing the display device to change channels.

22. The electronic device of claim 20, wherein the processor is configured to execute the instructions such that the processor and memory are configured to:
receive similar channel information from the server, the similar channel information indicating a third channel providing playback of a third media content similar to one or both of the first media content or the second media content, the third channel not indicated in the watched channel information that represents channels being watched on the display device; and
generate a second hot button on the GUI, the second hot button configured to cause the assistant device to instruct the display device to switch playback to the third media content by selecting the third channel.

23. The electronic device of claim 20, wherein instructing the display device to switch from playing back the second media content via the second channel to play back the first media content via the first channel based on the selection of the first hot button includes transmitting infrared (IR) signals to the display device, the IR signals representing that the display device should select the first channel.

24. The electronic device of claim 20, wherein the processor is configured to execute the instructions such that the processor and memory are configured to:
receive graphical content related to similar subject matter of both of the first media content and the second media content; and
display the graphical content on the GUI with the first hot button.

25. The electronic device of claim 20, wherein the processor is configured to execute the instructions such that the processor and memory are configured to:
determine that the second channel providing playback is currently selected by the display device for playback, wherein generating the first hot button is based on the determination that the second channel is currently selected by the display device for playback.

26. The electronic device of claim 20, wherein the media content information representing information regarding the first media content being played back on the first channel includes a characteristic of a live broadcast corresponding to the first media content.

27. The electronic device of claim 20, wherein the processor is configured to execute the instructions such that the processor and memory are configured to:
determine that the first channel and the second channel have each been selected for playback on the display device for a threshold number range within a threshold time duration, wherein the watched channel information is based on the determination that the first channel and the second channel have each been selected for playback on the display device for the threshold number range within the threshold time duration.

28. The electronic device of claim 20, wherein the processor is configured to execute the instructions such that the processor and memory are configured to:
determine activity of a user watching the display device, wherein the watched channel information is based on the determination regarding the activity of the user watching the display device.
